(19) United States
(12) Patent Application Publication
(10) Pub. No.: US 2004/0187666 A1
(43) Pub. Date: Sep. 30, 2004

(54) Table saw

(75) Inventor: Peter Huang, Taichung (TW)

Correspondence Address: BACON & THOMAS, PLLC, 625 SLATERS LANE, FOURTH FLOOR, ALEXANDRIA, VA, 22314

(73) Assignee: DURQ MACHINERY CORP., TAICHUNG (TW)

(21) Appl. No.: 10/395,178

(22) Filed: Mar. 25, 2003

(51) Int. Cl. B27B 5/29; B27B 5/24

(52) U.S. Cl. 83/477.2; 83/859

(57) ABSTRACT

A table saw is constructed to include a machine base supporting a work table, a saw blade pivotally mounted in a slot in the work table for cutting the workpiece, a blade guard detachably mounted on the worktable to protect the saw blade, a rip fence detachably mounted on the work table, two brackets bilaterally located on one peripheral side of the machine base. The brackets each has a rear retaining part and a front receiving open chamber for securing the rip fence and the blade guard after removal of the rip fence and the blade guard from the work table.

### BACKGROUND OF THE INVENTION

1. Field of the Invention

The present invention relates generally to table saws and, more particularly, to such a table saw, which has storage means for storing detachable parts removed from the table saw.

2. Description of the Related Art

A regular table saw, as shown in FIG. 1, is generally comprised of a machine base 1, a table 2, a saw blade 3, a blade guard 4, a mounting plate 5, and a rip fence 6. The machine base 1 supports the table 2 on the floor. The saw blade 3 is vertically adjustably installed in a saw slot in the table 2. When the saw blade 3 adjusted to an elevation where a part of the teeth protruding over the top side of the table 2, the saw blade 3 can be driven to cut the workpiece. The blade guard 4 is a transparent guard adapted to protect the saw blade 3, having one end pivoted to the mounting plate 5, which is fastened to the table 2. The rid fence 6 is transversely provided at the top side of the table 2 and horizontally movable relative to the saw blade 3 for stopping the workpiece in the cutting position for cutting by the saw blade 3. This design of table saw is functional, however it still has numerous drawbacks as outlined hereinafter.

1. When the blade guard, mounting plate, rib fence of the table saw removed from the table, the user must find an external storage place to keep the detached parts of the table saw, i.e., the machine base has no room for storing parts or other accessories.

2. The whole structure of the table saw is heavy, not conveniently movable. When wishing to change the installation place of the table saw or to move the table saw to another place for cleaning, it requires many personals to carry the heavy table saw to the desired place.

3. When carrying the table saw to another place, the blade guard tends to be vibrated and damaged, and the rib fence may be forced out of place.

Therefore, there is desirable to provide a table saw that eliminates the aforesaid drawbacks.

### SUMMARY OF THE INVENTION

The present invention has been accomplished under the circumstances in view. It is one object of the present invention to provide a table saw, which has means to receive detached parts of the table saw in good order.

It is another object of the present invention to provide a table saw, which is equipped with wheels convenient for moving.

It is still another object of the present invention to provide a table saw that requires less storage space when packed for delivery.

To achieve these objects of the present invention, the table saw comprises a machine base; a work table supported on the machine base and having an elongated slot thereon and a saw blade detachably mounted in the elongated slot; a rip fence detachably mounted on the work table and horizontally adjustable relative to the saw blade for stopping a workpiece in place for cutting by the saw blade; and a blade guard detachably mounted on the work table and adapted to protect the saw blade. Wherein the table saw further comprises a bracket unit protruded from one peripheral side of the machine base and adapted to receive the rip fence and the blade guard after removal of the rip fence and the blade guard from the work table, the bracket unit having retaining means adapted to retain the rip fence and holder means adapted to receive the blade guard.

### BRIEF DESCRIPTION OF THE DRAWINGS

FIG. 1 is a perspective view of a table saw constructed according to the prior art.

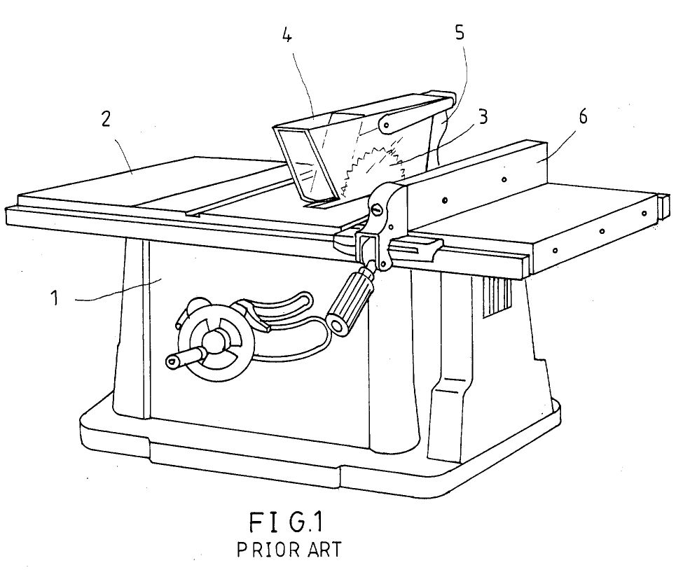

FIG. 2 is a perspective view of a table saw constructed according to a preferred embodiment of the present invention.

FIG. 3 is an exploded view in an enlarged scale of a part of the table saw according to the present invention.

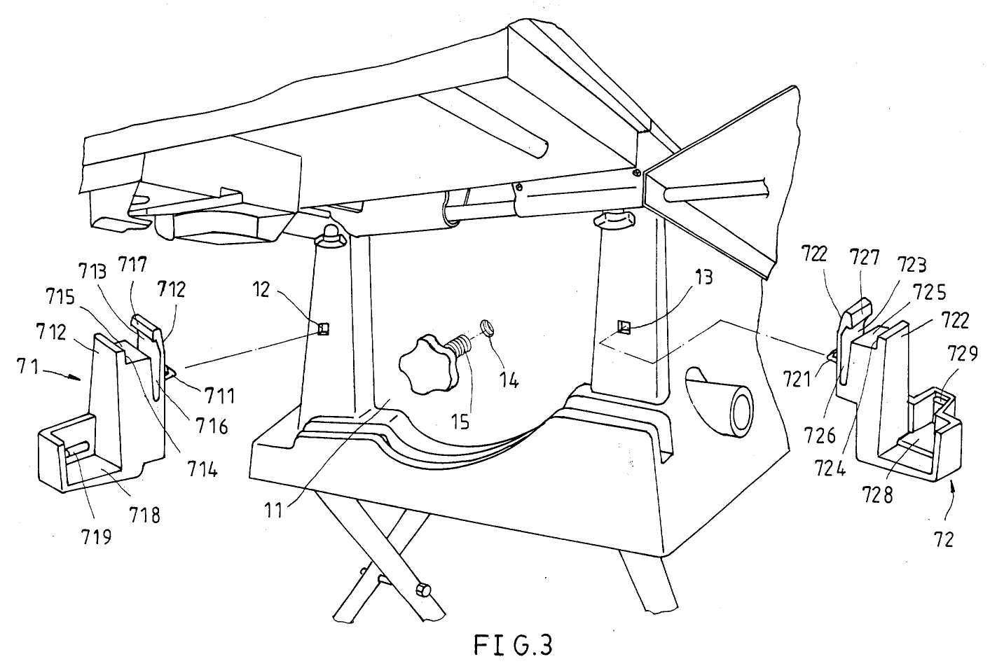

FIG. 4 is an enlarged view of a part of the table saw according to the present invention, showing the positioning of the bracket unit in the machine base and the received status of the saw blade and the wrench in the machine base.

FIG. 5 is an enlarged view of a part of the table saw according to the present invention, showing the rip fence received in the brackets.

FIG. 6 is an enlarged view of a part of FIG. 5, showing the retaining flange hooked in the longitudinal groove of the rip fence.

FIG. 7 is a perspective view in an enlarged scale of a part of the present invention, showing the blade guard and the rip fence received in the brackets.

FIG. 8 is schematic drawing showing the blade guard positioned in the brackets according to the present invention.

FIG. 9 is similar to FIG. 8 but showing the mounting plate turned outwards, the notch of the mounting plate disengaged from the rib of the right bracket.

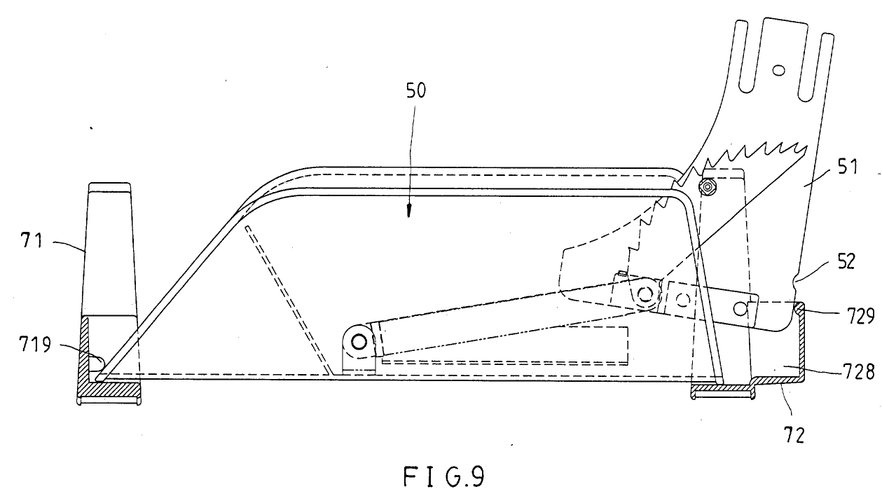

FIG. 10 is a schematic drawing showing the table saw moved on the floor by the user according to the present invention.

### DETAILED DESCRIPTION OF THE INVENTION

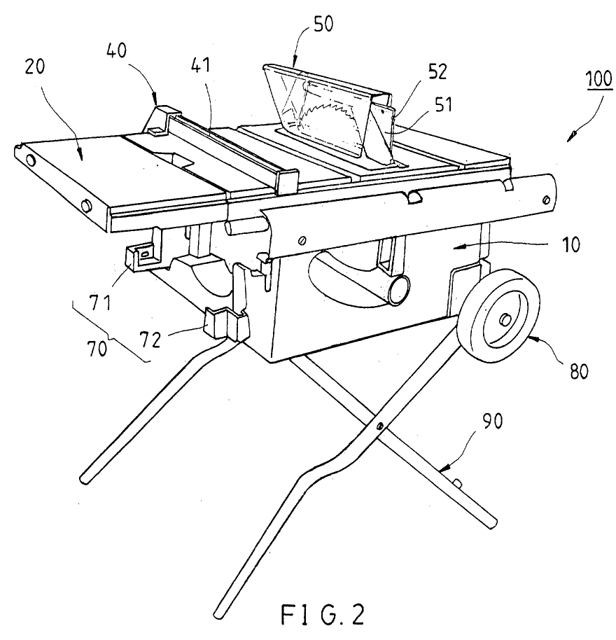

Referring to FIG. 2˜4, a table saw 100 is shown comprised of a machine base 10, a work table 20, a saw blade 30, a rib fence 40, a blade guard 50, a wrench 60, a bracket unit 70, two wheels 80, and a folding stand 90. The machine base 10, the work table 20, the saw blade 30, the rip fence 40, the blade guard 50, and the wrench 60 are similar to equivalent members of prior art designs. The main features of the present invention are outlined hereinafter.

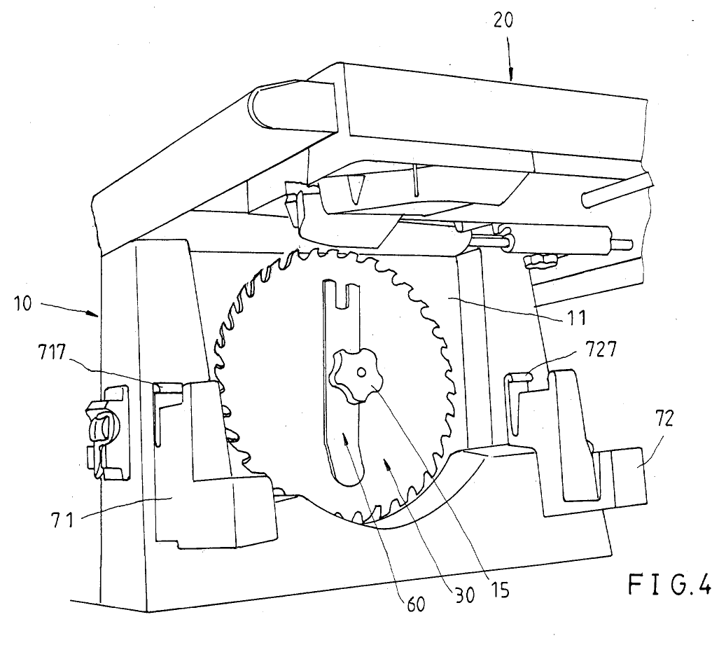

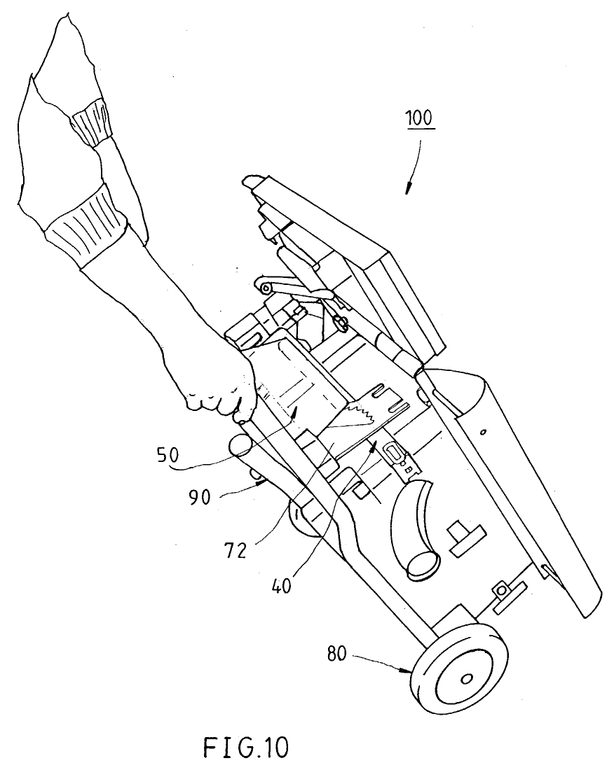

The machine base 10 has a recessed receiving chamber 11 formed in one vertical peripheral side, namely, the rear vertical peripheral side on the middle, two hook holes 12 and 13 symmetrically disposed in the rear vertical peripheral side at two sides of the recessed receiving chamber 11, and a screw hole 14 located on the center of the recessed receiving chamber 11 for the mounting of a hand screw 15 to secure the saw blade 30 and the wrench 60 to the inside of the recessed receiving chamber 11 when the saw table 100 not in use (see FIG. 4). The wheels 80 are bilaterally pivoted to the two opposite bottom corners of an opposite vertical peripheral side, namely, the front vertical peripheral side of the machine base 10, and disposed outside the machine base 10. The folding stand 90 is fastened pivotally with the bottom wall of the machine base 10, and alternatively set between the extended position where the folding stand 90 supports the machine base 10 above the floor (see FIG. 2) and the received position where the wheels 80 touch the floor to make the table saw 100 easy to move (see FIG. 10).

The rip fence 40 is detachably mounted on the top side of the work table 20, having a longitudinal groove 41 in the top side.

The blade guard 50 is adapted to protect the saw blade 30, having a mounting plate 51 pivoted to one end thereof The mounting plate 51 is detachably fastened to the work table 20, having a notch 52 in the outer end thereof near the top.

The bracket unit 70 comprises a left bracket 71 and the right bracket 72. The brackets 71 and 72 are respectively molded from plastics, each having a hook 711 or 721 for hooking in the hook hole 12 or 13 to secure the respective bracket 71 or 72 to the machine base 10. The left bracket 71 comprises two uprights 712 arranged in parallel at a rear side, a first vertical stop face 713 and a second vertical stop face 714 respectively formed in the respective vertical inner side of the uprights 712 and facing each other, a horizontal bearing face 715 perpendicularly extended from the second vertical stop face 714 toward the second vertical stop face 713, a vertical crevice 716 disposed between the first vertical stop face 713 and the horizontal bearing face 715 below the elevation of the horizontal bearing face 715, a retaining flange 717 formed in one upright 712 at the top of the first vertical stop face 713, a receiving open chamber 718 disposed in front of the uprights 712 at a relatively lower elevation, and a rib 719 suspended inside the receiving open chamber 718 near the bottom. Due to the presence of the vertical crevice 716, the uprights 712 can be bent outwards in reversed directions. The receiving open chamber 718 has an open top side and a close bottom side.

The right bracket 72 comprises two uprights 722 arranged in parallel at a rear side, a first vertical stop face 723 and a second vertical stop face 724 respectively formed in the respective vertical inner side of the uprights 722 and facing each other, a horizontal bearing face 725 perpendicularly extended from the second vertical stop face 724 toward the second vertical stop face 723, a deep groove 726 disposed between the first vertical stop face 723 and the horizontal bearing face 725 below the elevation of the horizontal bearing face 725, a retaining flange 727 formed in one upright 722 at the top of the first vertical stop face 723, a stepped receiving open chamber 728 disposed in front of the uprights 722 at a relatively lower elevation, and a rib 729 suspended inside the stepped receiving open chamber 728 near the bottom. The stepped receiving open chamber 718 has an open top side and a close bottom side.

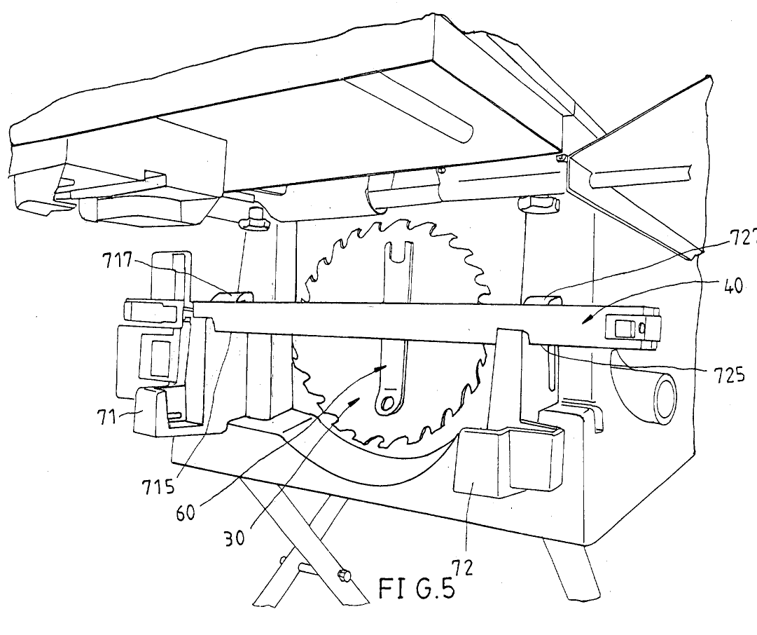

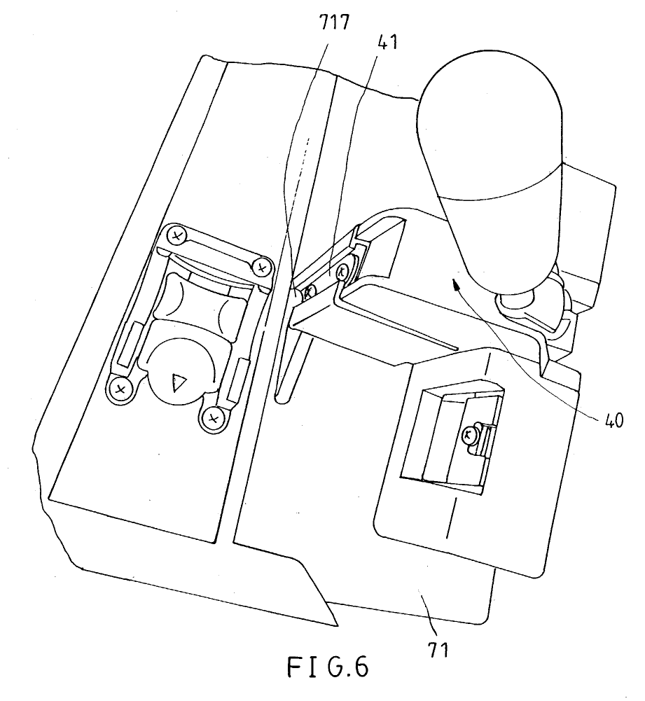

The aforesaid statement described the parts of the table saw 100 and their relative positioning. The stop faces and bearing faces of the aforesaid bracket unit 70 form a retaining structure adapted to receive the rip fence 40. As illustrated in FIGS. 5 and 6, after removal of the rip fence 40 from the work table 20, the rip fence 40 is inserted into the brackets 71 and 72, keeping the top side facing the machine base 10, one lateral side supported on the respective horizontal bearing faces 715 and 725, and the bottom side respectively stopped at the respective second vertical stop faces 714 and 724 of the brackets 71 and 72. When set into position, the retaining flanges 717 and 727 of the brackets 71 and 72 are respectively hooked in the longitudinal groove 41 of the rip fence 40 to hold down the rip fence 40 in the brackets 71 and 72. When biasing the rip fence 40 to stretch the uprights 712 and 722 of the brackets 71 and 72, the rip fence 40 can then easily be removed from the brackets 71 and 72.

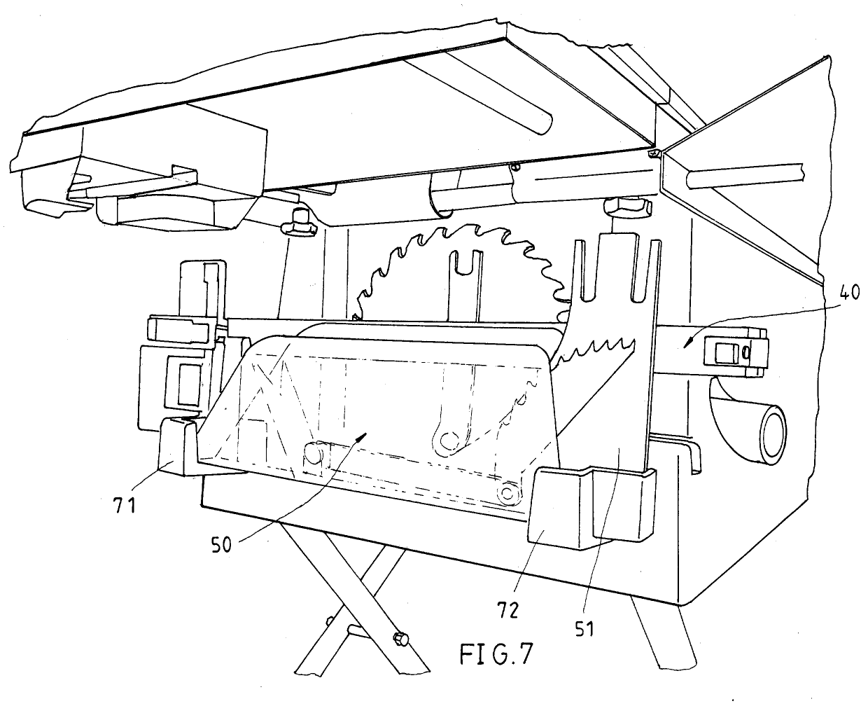

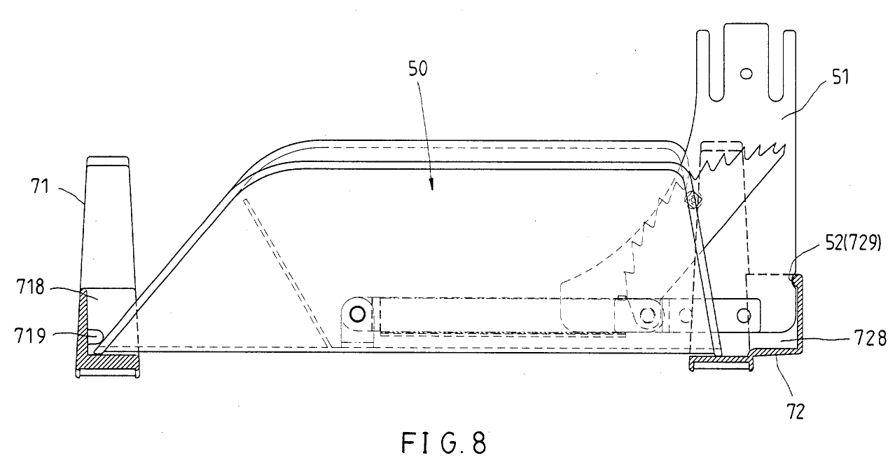

Further, the receiving open chambers 718 and 728 of the brackets 71 and 72 are adapted to accommodate the blade guard 50. As illustrated in FIGS. 7 and 8, after removable of the blade guard 50 with the mounting plate 51 from the work table 20, the blade guard 50 is turned upside down and then put in the receiving open chambers 718 and 728 of the brackets 71 and 72. When set in position, the rib 719 of the first bracket 71 is stopped against one side edge of the blade guard 50, and the rib 729 of the right bracket 72 is engaged into the notch 52 of the mounting plate 51. When wishing to remove the blade guard 50 from the brackets 71 and 72, turn the mounting plate 51 outwards to move the blade guard 50 relative to the brackets 71 and 72, thereby causing the notch 52 to be disengaged from the rib 729 of the right bracket 72.

As indicated above, the installation of the bracket unit 70 does not hinder cutting operation of the table saw 100. When the table saw 100 not in use, the user can remove the rip fence 40 and the blade guard 50 with the mounting plate 51 from the work table 20 and then receive the rip fence 40 and the blade guard 50 with the mounting plate 51 in the bracket unit 70.

Further, when the folding stand 90 received, the wheels 80 are peripherally disposed in contact with the floor, as shown in FIG. 10, and the user can move the table saw 100 on the floor conveniently with less effort. Because the detached parts (the rip fence, the blade guard, and the wrench) are well received in one side of the machine base 10 remote from the wheels 80, they do not fall from the table saw 100 during movement of the table saw 100.

What is claimed is:

1. A table saw comprising:
a machine base;
a work table supported on said machine base and having an elongated slot for detachably mounting a saw blade therein;
a rip fence detachably mounted on said work table and horizontally adjustable relative to said saw blade; and
a blade guard detachably mounted on said work table and adapted to protect said saw blade;
wherein:
the table saw further comprises a bracket unit protruded from one peripheral side of said machine base, said bracket unit having retaining means for retaining said rip fence after removal of said rip fence from said work table and holder means for receiving said blade guard after removal of said blade guard from said work table.

2. The table saw as claimed in claim 1, wherein said bracket unit comprises a left bracket and a right bracket bilaterally installed in said peripheral side of said machine base, said left bracket and said right bracket each having a first vertical stop face, a second vertical stop face facing said first stop face, a horizontal bearing face disposed between said first vertical stop face and said second vertical stop face, and a receiving open chamber disposed outside said first and second vertical stop faces, said receiving open chamber having an open top side and a close bottom side, the vertical stop faces and horizontal bearing faces of said left and right brackets forming said retaining means, the receiving open chambers of said left and right brackets forming said holder means.

3. The table saw as claimed in claim 2, wherein said left and right brackets are molded from plastics and shaped like a stepped block, each having a relatively lower front side forming the respective receiving open chamber and a relatively taller rear side forming the respective first and second vertical stop faces and the respective horizontal bearing face.

4. The table saw as claimed in claim 3, wherein the relatively taller rear side of each of said left and right brackets comprises two parallel uprights, said uprights each having an inner side forming the first vertical stop face and second vertical stop face of the respective bracket.

5. The table saw as claimed in claim 4, wherein said left bracket and said right bracket each further comprises a vertical crevice disposed between the respective horizontal bearing face and the respective first vertical stop face at a lover elevation than the respective horizontal bearing face.

6. The table saw as claimed in claim 5, wherein said rip fence is insertable in between the first vertical stop face and second vertical stop face of each of said left and right brackets, having a longitudinal groove; said left and right brackets each further comprise a retaining flange protruded from a top of the respective first vertical stop face and adapted to engage the longitudinal groove of said rip fence upon insertion of said rip fence into said left and right brackets.

7. The table saw as claimed in claim 3, wherein said left and right brackets each further comprise a rib suspended in the respective receiving open chamber of the respective lower front side and adapted to secure said blade guard in position after insertion of said blade guard into the receiving open chambers of said left and right brackets; said blade guard has a pivoted mounting plate for fastening to said work table, said mounting plate having a notch disposed in an outer side thereof, which is forced into engagement with the rib in the receiving open chamber of said right bracket when said blade guard inserted into said left and right brackets.

8. The table saw as claimed in claim 3, wherein said peripheral side of said machine base has two hook holes symmetrically disposed at two sides; said left and right brackets each have a back hook respectively hooked in the hook holes of said machine base.

9. The table saw as claimed in claim 8, wherein said machine base comprises two wheels respectively pivoted to two opposite bottom corners of one peripheral side opposite to the peripheral side in which said left and right brackets are installed.

10. The table saw as claimed in claim 9, wherein said machine base has a folding stand provided at a bottom side thereof, said folding stand being alternatively set between an extended position to support said machine base on the floor and a received position let the table saw be moved on the floor by means of said wheels.
